(19) United States
(12) Patent Application Publication
(10) Pub. No.: US 2002/0155225 A1
(43) Pub. Date: Oct. 24, 2002

(54) Method for charge-modifying polyester

(76) Inventors: Eshan B. Yeh, Unionville, CT (US); Eugene A. Ostreicher, Farmington, CT (US); Richard D. Sale, Tolland, CT (US); Marjorie B. Bucholz, Meriden, CT (US)

Correspondence Address: CUMMINGS & LOCKWOOD, Four Stamford Plaza, P.O. Box 120, Stamford, CT, 06904-0120, US

(21) Appl. No.: 09/922,879

(22) Filed: Aug. 6, 2001

Related U.S. Application Data
(60) Provisional application No. 60/223,183, filed on Aug. 4, 2000.
(60) Provisional application No. 60/223,184, filed on Aug. 4, 2000.

(51) Int. Cl. B05D 3/02; B05D 1/18; B05D 1/36; B05D 3/10

(52) U.S. Cl. 427/407.1; 427/299; 427/322; 427/430.1; 427/384

(57) ABSTRACT

A method for producing charge-modified polyester comprising treating the polyester with at least one agent sufficient to cause hydrolysis of the polyester and a charge-modifier having one or more epoxy groups with a fixed formal charge, resulting in the formation of a bond between the one or more epoxy groups and the polyester. The polyester may be treated with the agent, which is presently preferred to be an alkaline, amine, or combination of both, and charge-modifier, which could have a positive or negative charge.

### CROSS-REFERENCE TO RELATED APPLICATIONS

This application is a continuation-in-part of commonly owned U.S. Provisional Patent Application Serial No. 60/223,183 of Bucholz, et al., filed August 4, 2000, entitled “METHOD FOR CHARGE-MODIFYING POLYESTER,” and related to commonly owned U.S. Provisional Patent Application Serial No. 60/223,184 of Yeh, et al., filed Aug. 4, 2000, entitled “CHARGE-MODIFYIED DYE ABSORPTION MEDIA,” the disclosures of which are incorporated herein by reference to the extent not inconsistent with the present application.

### BACKGROUND OF THE DISCLOSURE

The present disclosure is directed to compositions and methods for chemically-altering substrates to produce a positive zeta potential thereon. More particularly, the present disclosure relates to cationically-charged substrates useful for scavenging and segregating anionic materials, and a method for producing cationically-charged substrates. The disclosed method operates to efficiently charge-modify polyester substrates to produce a positive zeta potential.

Materials chemically-modified to carry charge are used in a wide array of industries for a large variety of applications. For example, charge-bearing materials have found widespread use in filtration procedures, chromatography and separation techniques, immobilization matrices, photography, xerography, and even in dye scavenging applications and dust clothes.

Numerous methods have been proposed for chemical charge-modification. Various materials have been modified in the prior art to carry anionic or cationic charges.

U.S. Pat. No. 4,604,208 to Chu et al. describes an anionic charge modified nylon microporous filter membrane. The charge-modifying system is a water soluble polymer having substituents thereon capable of bonding to membrane and anionic functional groups such as carboxyl, phosphorous, phosphonic and sulfonic groups. A cross-linking agent may also be utilized, e.g., aliphatic polyepoxides.

U.S. Pat. Nos. 4,645,567 to Hou et al. discloses a process for production of anionically charged filter elements with cationic charge-modifiers, preferably, employing inorganic colloidal silica charge modifiers. The inorganic cationic charge-modifier is used to modify the anionic charge of cellulose pulp and particular filter aid and permit deposition of a level of inorganic anionic charge modifier thereon to provide enhanced electrokinetic charge potential. A particularly useful inorganic anionic charge modifier is disclosed to be inorganic anionic colloidal silica.

Japanese Patent No. 923649 and French Patent No. 7415733 disclose an isotropic cellulose mixed-ester membrane treated with a cationic colloidal melamine formaldehyde resin to provide charge functionality. Treatment of nylon membranes prepared by the methods described in U.S. Pat. Nos. 2,783,894 to Lovell (1957) and 3,408,315 to Paine (1968) is suggested therein.

U.S. Pat. Nos. 4,473,475 and 4,743,418 to Barnes et al. describes a cationic charge-modified microporous nylon membrane having bonded thereto, through a cross-linking agent, a charge modifying amount of an aliphatic amine or polyamine, preferably tetraethylene pentamine. The cross-linking agent is an aliphatic polyepoxide having a molecular weight of less than about 5000, preferably 1,4 butanediol diglycidyl ether. Such a membrane is said to exhibit an advantageously low “flush-out” time.

U.S. Pat. No. 4,601,828 to Gershoni discloses a charge-modified microporous membrane for transfer of macromolecules such as nucleic acid and proteins from a chromatographic substrate to an immobilizing matrix. The membrane comprises a hydrophilic, organic, microporous membrane having a charge-modifying amount of a cationic charge-modifying agent bonded to substantially all of the wetted surfaces of the membrane. The cationic charge-modifying agent is characterized as a water-soluble organic polymer having a molecular weight greater than about 1,000, wherein each monomer thereof has at least one epoxide group capable of bonding to the surface of the membrane and at least one tertiary or quaternary ammonium group. It is preferred that a portion of the epoxy groups on the organic polymer be bonded to a secondary charge modifying agent such as an aliphatic amine having at least one primary amino or at least two secondary amino groups and a carboxyl or hydroxyl substitutent. The charge-modifying agent may also be an aliphatic amine or polyamine bonded to the membrane through a cross-linking agent which is an aliphatic amine having a molecular weight of less than about 500. The preferred microporous membrane is nylon.

U.S. Pat. Nos. 4,473,474, 4,673,504 and 4,708,803 disclose a cationically charge-modified microporous membrane suitable for filtration of aqueous fluids, such as biological fluids, comprising a hydrophilic organic polymeric microporous membrane and a cationic charge-modifying agent bonded to substantially all of the wetted surfaces of the membrane. The charge-modifying agent is an epichlorohydrin-modified polyamide having tertiary amine or quaternary amine groups. A secondary charge-modifying agent may be employed selected from: (i) aliphatic polyamines having at least one primary amine or at least two secondary amines; and (ii) aliphatic amines having at least one secondary amine and a carboxyl or hydroxyl substituent.

U.S. Pat. No. 4,711,793 to Ostreicher et al. discloses cationic charge modification of a substantially hydrophilic microporous filter membrane, preferably made from nylon, employing a charge modifying agent which is a reaction product of a polyamine and epichlorohydrin, the reactive product having tertiary or quaternary ammonium groups and epoxide groups along a polyamine chain. The epoxide groups along the polyamine chain are capable of bonding to the microstructure of the membrane. The preferred charge-modifiers are polyamido-polyamine epichlorohydrin or polyamine epichlorohydrin. The primary charge-modifying agent is bonded to substantially all of the wetted surface of the microporous membrane and is a water-soluble organic polymer having a molecular weight greater than about 1000. A secondary charge-modifying agent may be used to enhance the cationic charge of the primary charge-modifying agent and/or enhance the bonding of the primary charge-modifying agent to the microporous surface and/or itself. The secondary charge-modifying agent is selected from the group consisting of: (i) aliphatic amines having at least one primary amine or at least two secondary amines; and (ii) aliphatic amines having at least one primary amine and a carboxyl or hydroxyl substituent.

U.S. Pat. Nos. 4,743,418 and 4,737,418 to Barnes, Jr. et al., discloses a hydrophilic charge-modified microporous membrane, preferably made of nylon. The membrane has bonded to it, through a cross-linking agent, a charge-modifying amount of a cationic charge-modifying agent. The charge-modifying agent is an aliphatic amine or polyamine, preferably tetraethylene pentamine, and the cross-linking agent is an aliphatic polyepoxide having a molecular weight of less than about 500, preferably 1,4-butanediol diglycidyl ether.

U.S. Pat. No. 4,859,340 to Hou et al. discloses a hydrophilic filter media sheet comprising fine particulate and a self-bonding matrix of cellulose fiber, the surfaces of at least one of which are modified with a polyamido-polyamine epichlorohydrin cationic resin, the matrix incorporating beaten cellulose fiber to provide a Canadian Standard Freeness of less than 600 ml.

U.S. Pat. No. 4,980,067 to Hou et al. discloses a hydrophilic microporous membrane which is charge-modified by coating or grafting thereon a water-soluble polymer having polyquaternary ammonium groups separated by hydrophobic groups comprising aromatic groups or alkyl groups containing at least six carbon atoms. The preferred charge-modifying agents are the polyamido-polyamine epichlorohydrin-cationic resins. The preferred secondary charge-modifying agents include polyamines such as tetraethylene pentamine. A preferred microporous material is nylon.

U.S. Pat. Nos. 4,981,591, 5,085,780 and 5,085,784 disclose a process for removing contaminants from a fluid by passing the fluid through a filter media comprising filter elements of cellulose fiber and silica-based particulate or fiber and a charge-modifying amount of a cationic charge-modifying system bonded to the surfaces of the elements, where the cationic charge-modifying system comprises: (i) a primary charge-modifying agent which is a water soluble organic polymer capable of being adsorbed onto the elements and having a molecular weight of greater than about 1000, each monomer of the polymer having at least one epoxide group capable of bonding to the surfaces of the elements and quaternary ammonium groups; and (ii) a secondary charge modifying agent bonded to a portion of the epoxy groups on the organic polymer, wherein the secondary charge modifying agent is an aliphatic polyamine having at least one primary amine or at least two secondary amines.

U.S. Pat. No. 5,004,543 to Pluskal et al. discloses a hydrophobic material having a crosslinked, cationic charge-modifying coating such that the majority of the ion exchange capacity of the material is provided by fixed formal positive charge groups. The material is produced by contacting a hydrophobic substrate with a mildly alkaline, aqueous organic solvent solution into which has been dissolved a cationic charge-modifying agent. The charge-modifying agent comprises a water soluble, organic polymer having a molecular weight of greater than about 1000, wherein the polymer chain contains both fixed formal positive charge groups and halohydrin groups. Agents containing epichlorohydrin substituents as well as quaternary ammonium ions are specified to be most preferred. The charge-modified, hydrophobic membranes are taught not to be subjected to a treatment with a secondary charge-modifying agent such as tetraethylene pentamine. Membranes fabricated from polypropylene, polyethylene, polysulphone, polytetrafluoroethylene, and polyvinylidene fluoride (PVDF) are all referenced as useful. Hydrophobic PVDF membranes are preferred. The materials produced may be used in macromolecular blotting and filtration.

Polyester fibers, of which PET (poly(ethylene terephthalate)) and PBT (poly(butylene terephthalate)) are the two popular ones, have many applications only after they are surface treated. Untreated polyester fabric has little affinity toward moisture and can easily build up static charge, and its application would be greatly limited. Examples of such treatments have been summarized in a review “Surface Modification of Polyester by Alkaline Treatments”, Textile Progress, Vol.20, No. 2, 1, 1989.

U.S. Pat. No. 4,747,955 to Kunin, discloses a process of treating polyester fibers with hot caustic solution that contains a surfactant. The polyester fibers can be further treated with cationic or anionic polyelectrolytes, as disclosed in U.S. Pat. No. 4,177,142 to Halbfoster, or cationic or anionic exchange resins, as disclosed in U.S. Pat. No. 4,190,532 to Halbfoster, or other active particulate particles such as active carbon, as disclosed in U.S. Pat. No. 4,238,334 to Halbfoster. In all of these, there is no definite covalent bond described that can hold attached species of a charged or non-charged nature in a permanent fashion.

U.S. Pat. No. 5,855,623 to English et al, discloses modifying polyester and other types of fabrics by polymerizing a monomer solution on the surface of the fabrics. Again, there are no covalent bonds between the polymer coating and substrate.

U.S. Pat. No. 5,565,265 to Rubin et al., discloses coating polyester and other types of fabrics with acrylic polymers that contain other ingredients such as biocide and/or stain resistant fluorochemicals. The coatings are not permanently fixed and there is no charge involved.

U.S. Pat. No. 5,997,584 to Andersen et al., discloses treating polyester fabrics with a hydrolytic enzyme and a detergent. Once again, there is no permanent covalent bonding between the substrate and the modifying agent.

Previously, the art has directed one seeking to chemically-modify materials to produce high positive charge thereon, towards charge-modification of materials having a high degree of free hydroxyl functionalities (which may easily be converted to anionic functional groups—See, e.g., U.S. Pat. No. 5,881,412 at Col. 6, Lines 48-50) or to hydrophilic materials. In particular, preferred materials for chemically effectuating a positive zeta-potential included cellulosic materials (See, e.g., U.S. Pat. No. 4,380,453 at Col. 2, Lines 47-49) such as cotton and rayon, or amide containing hydrophilic materials such as nylon. Because of these teachings, it was not at all obvious that a material such as polyester lacking such groups could be effectively charge-modified. In fact, there was no reason for a person skilled in the art to even consider using a material lacking such groups.

It has been reported (Textile Progress: Surface Modification of Polyester by Alkaline Treatments in Textile Institute Vol2, No. 2, pp. 1-26 (1989)) that the affinity of polyester fiber fabric for moisture can be significantly improved by treating the fabric with alkaline or amine agents. It has been hypothesized that polyester undergoes nucleophilic substitution and is hydrolysed by alkaline agents, such as aqueous sodium hydroxide. It is believed that hydroxyl ions attack the electron-deficient carbonyl carbons of polyester to form an intermediate anion, followed by chain scission to produce free hydroxyl and carboxylate end-groups. Reports of improvement of certain physical properties of polyester by reaction with amines has been known almost since the discovery of polyester (See, e.g., U.S. Pat. No. 2,590,402 (Mar. 25, 1952). It is similarly hypothesized that polyester fabric undergoes nucleophilic substitution during aminolysis. It is believed that the amine attacks the electron-deficient carbonyl carbon with subsequent chain scission occurring at such site, and amide formation. It also has been suggested that the amine groups on the surface of the polyester may provide sites for subsequent chemical reactions.

In application, a surface modified polyester will face a variety of chemical environments and physical demands. Therefore, for greater stability and integrity as well as improved characteristics including dyeability, wettability, particle filtration, air venting, and better capture of stray dyes, a permanent covalent bonding between the substrate and modifying species is desirable.

### SUMMARY OF THE DISCLOSURE

It is an object of the disclosure to permanently modify polyester surfaces by changing the surface properties, through means such as hydrolysis, and treating the polyester with a modifying species comprising one or more epoxy groups. The one or more epoxy groups bond covalently or otherwise with the hydrolyzed polyester and results in modifications to the polyester. For example, a positive or negative charge may be added, the surface tension may be modified, and hydrophilic or hydrophobic properties may be imparted by the one or more epoxy groups.

In one embodiment of the present disclosure, there is disclosed a process for preparing a charge modified medium comprising polyester substrate, the process comprising the steps of: (a) treating the medium with an alkaline agent so as to cause alkaline hydrolysis of polyester in the medium; (b) applying to the treated medium of step (a) a poly-epoxy charge modifier having a fixed formal positive charge, one or more epoxy groups of the charge modifier being capable of bonding to said treated medium. Steps (a) and (b) may take place concurrently, or sequentially.

In another embodiment of the present disclosure, there is disclosed a process for preparing a charge modified polyester substrate, the process comprising the steps of: (a) treating the medium with an amine agent so as to cause aminolysis of the polyester in the medium; (b) applying to the treated medium of step (a) a poly-epoxy charge modifier having a fixed formal positive charge, one or more epoxy groups of the charge modifier being capable of bonding to the treated medium. Steps (a) and (b) may take place concurrently, or sequentially.

In another embodiment of the present disclosure, there is disclosed a process for preparing a surface-modified polyester, the process comprising the steps of exposing the polyester to one or more agents sufficient to cause hydrolysis of the polyester and at least one modifier comprising one or more epoxy groups having either a positive or negative charge, or hydrophilic or hydrophobic properties, wherein the one or more epoxy groups bond with the polyester and impart the positive or negative charge, or hydrophilic or hydrophobic properties to the polyester. The exposures may take place concurrently or sequentially.

There is disclosed yet another process for preparing a charge-modified medium comprising polyester substrate comprising: (a) treating the medium with an alkaline agent so as to cause alkaline hydrolysis of polyester in the medium and with an amine compound so as to cause aminolysis of polyester in said medium; (b) applying to the treated medium of step (a) a poly-epoxy charge modifier having a fixed formal positive charge, one or more epoxy groups of the charge modifier being capable of bonding to said treated medium. Steps (a) and (b) may take place concurrently, or sequentially.

In yet another embodiment of the present disclosure, there is disclosed a process for removing anionic materials from a liquid comprising exposing the liquid to a cationically charge-modified polyester substrate having a positive zeta potential such that the metanil yellow binding capacity is at least 0.004 mg metanil/1.0 gram of substrate, the charge-modified polyester substrate comprising: (a) polyester; (b) a polymeric cationic charge-modifying agent, the cationic charge-modifying agent being chemically bonded to the polyester.

Further disclosed is a process for cationically charge-modifying a polyester substrate, the process comprising: chemically bonding a charge-modifying amount of a cationic charge-modifying agent to the polyester so as to charge-modify substantially all of said polyester, wherein the charge-modifying agent comprises a polymer consisting of a plurality of monomers each bearing a fixed formal positive charge and one or more epoxide groups, said epoxide groups capable of reacting with said polyester to form a chemical bond when said polyester is exposed to a quantity of alkaline agent(s) sufficient to cause alkaline hydrolysis of the polyester and/or a quantity of amine compounds sufficient to cause aminolysis of the polyester substrate. In a presently preferred embodiment, alkaline hydrolysis takes place over a period of time less than about 20 minutes.

There is further disclosed a process for preparing a charge-modified polyester substrate, comprising: applying to the medium a charge-modifying system comprising: (a) a charge-modifying agent comprising one or more epoxy groups and fixed formal positive charged groups, said epoxy groups capable of bonding to the surface of polyester when the polyester is chemically modified to produce free carboxy or amine functionalities; (b) an alkaline agent in sufficient concentration to cause alkaline hydrolysis of the polyester; (c) a aliphatic polyamine (which may be tetraethylene pentamine) in sufficient concentration to cause aminolysis of the polyester.

In another embodiment in accordance with the present disclosure, there is disclosed a method for producing a positively-charged polyester, comprising: (a) immersing a polyester substrate into an aqueous organic solvent containing a polyamine in a concentration, and for a time, sufficient to cause aminolysis of said polyester; (b) reacting the polyester of step (a) with a poly-epoxy charge-modifier carrying a fixed formal positive charge; (c) drying the polyester of step (b).

In a presently preferred embodiment, aminolysis takes place over a period of time less than about 20 minutes. Similarly, there is disclosed a method for producing a positively-charged polyester substrate, said method comprising: (a) immersing a polyester substrate into a solvent containing an alkaline agent in a concentration, and for a time, sufficient to cause alkaline hydrolysis of said polyester; (b) reacting the polyester of step (a) with a poly-epoxy charge-modifier carrying a fixed formal positive charge; (c) drying the polyester of step (b).

### BRIEF DESCRIPTION OF THE DRAWINGS

The above description, as well as further objects, features and advantages of the present disclosure will be more fully understood with reference to the following detailed description of method, for charge modifying polyester fabric, when taken in conjunction with the accompanying drawings, wherein:

FIG. 1 is a cut-away schematic of a two stage reaction procedure which may be employed to fabricate charged polyester substrate.

FIG. 2 is a cut-away schematic of a one stage reaction procedure which may be employed to fabricate charged polyester substrate.

FIG. 3 is a cut-away schematic of a “one pot” procedure to fabricate charged polyester substrate.

### DETAILED DESCRIPTION OF THE DISCLSOURE

Polyester fibers, although stable under most conditions, undergo hydrolytic reaction in basic condition. When such reaction occurs, the ester group is split into two parts: a hydroxyl part and a carboxylic part. A chemical reaction is presented below:

Polyester Hydrolysis in the Presence of NaOH

˜CO—C₆H₄—CO₂—CH₂—CH₂—O˜+NaOH→˜CO—C₆H₄—CO₂⁻+HO—CH₂—CH₂—O˜

In the presence of aqueous amine, the hydrolysis of polyester is aided by the amine and is called aminolysis. The products after aminolysis contain hydroxyl groups and amino groups. A chemical reaction is presented below:

Polyester Hydrolysis in the Presence of an Amine or Aminolysis

˜CO—C₆H₄—CO₂—CH₂—CH₂—O˜+RNH₂→˜CO—C₆H₄—CO—NHR+HO—CH₂—CH₂—O˜

Surprisingly, the present inventors have discovered that polymerized epoxy compounds which carry a fixed formal charge may advantageously be employed to charge-modify a polyester substrate after (or concurrent with) treatment of the polyester substrate with a sufficient concentration of an amine compound to cause aminolysis of the polyester and/or with a sufficient concentration of an alkaline agent to cause alkaline hydrolysis of the polyester. Thus, the groups formed in the above reactions, being reactive toward epoxy functional groups, allow any surface modifying agent that has epoxy group on it to be used to change the surface properties of polyester fibers. Examples of such reactions are illustrated below:

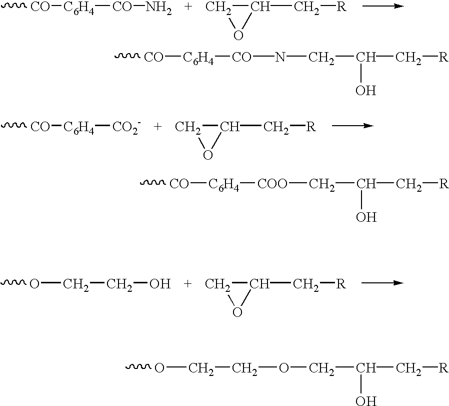

Where group R contains a surface modifying agent which may have either a positive or negative surface charge. For example, a hydrophilic group such as a hydroxyl group, a hydrophobic group such as fluoro-alkyl groups, or any other functional groups.

Further, the present inventors have discovered that the charge capacity of polyester is unexpectedly significantly increased when polyester is treated concurrently, or sequentially, so as to undergo both aminolysis and alkaline hydrolysis, in conjunction with treatment with the epoxy-charge modifier having fixed formal charge.

Charge modification may be accomplished by combining an aliphatic amine with an aliphatic diepoxide (e.g., 1,4 butanediol diglycidyl ether) in a reaction bath. Charge modification may also be accomplished by combining an aliphatic amine with a quatenary polyamino epichlorohydrin resin (e.g., Resicart E™, Ciba-Geigy®).

The present inventors have found that significant charge addition can easily be effectuated on polyester substrates by first causing the polyester substrate to undergo aminolysis, or alkaline hydrolysis, and then reacting (sequentially or concurrently) with an epoxy charge-modifier that carries a fixed formal charge. Substantially greater charge was able to be produced when the polyester was treated not only with a alkaline agent to cause alkaline hydrolysis by also with an amine compound to cause aminolysis.

The present process comprises reacting a polyester substrate chemically-treated to have free amine or carboxylic groups on its surface with a poly-epoxy charge modifier that has fixed formal charge groups. The surface modifying species is covalently bonded to the substrate of polyester. The surface is pre-hydrolyzed according to known methods to expose hydroxyl, carboxylic, or amino groups. The reaction is simplified by the following equations:

| | |
|---|---|
| ˜CO—C₆H₄—CO₂—CH₂—CH₂—O˜ + | Polyester hydrolysis |
| NaOH → ˜CO—C₆H₄—CO₂⁻ + HO—CH₂— | in the presence of |
| CH₂—O˜ | NaOH |
| ˜CO—C₆H₄—CO₂—CH₂—CH₂—O˜ + | Polyester hydrolysis |
| RNH₂ → ˜CO—C₆H₄—CO—NHR + | in the presence of |
| HO—CH₂—CH₂—O˜ | amines |

Preferably, the process entails use of one or more amino cross-linking agents to induce production of free amino groups on the polyester and to form relatively strong bonding links between functionalities of the charge modifier and the polyester substrate. Advantageously, the primary charge-modifier is a poly-epoxyamine and is a polymer of more than about two repeat units, more advantageously more than about fifty repeat units, and yet more advantageously more than about 100 repeat units, each of which preferably contains a quaternary amine. Polyester which is charge-modified using a poly-epoxyamine by the methods of the present disclosure has been demonstrated to possess an unexpectedly high zeta potential.

By “polyester substrate” it is meant a high surface area porous non-woven fabric made from fiber, particulate, or some combination of both, which is made from polymers in the polyester family (e.g., polytrimethylene terephthalate, polyethylene terephthalate [PET] or polybutyl terephthalate [PBT]), their co-polymers, or blends having a polyester as at least one component. Some suitable non-woven fabric polyesters include Reemay 2295 or Hollytex 3257. These fabrics may take the form of spunbond or meltblown media.

By “alkaline hydrolysis” it is meant a superficial, predominantly surface, treatment of the polyester substrate by an aqueous base solution such that the surface is altered without substantially weakening the physical integrity of the polyester substrate. Alkaline hydrolysis is believed to produce carboxyl functional groups on the surface through chain scission. A presently preferred range of pH for alkaline hydrolysis of the present disclosure is about 12 to about 13.

By “aminolysis” it is meant a superficial, predominantly surface, treatment of the polyester substrate by an amine (preferably aliphatic rather than aromatic). Low molecular weight aliphatic amines that are water or water/alcohol soluble may be used most effectively. Aliphatic amines such as tetraethylene pentamine and diethyl tetramine may be employed advantageously.

While not wishing to be bound by any theory, the inventors have hypothesized that reactivity of polyester with an amine/alkaline solution involves chemistries distinct from those involved in converting free hydroxyl moieties to anions, instead involving addition of free amine functionalities to the polyester and the formation of free carboxyl groups. It is further believed that such free amine and carboxyl moieties react with the epoxy functionality of the poly-epoxy charge modifier that carries the fixed formal positive charge permitting the charged functionality of the modifier to be chemically-bonded to the polyester.

A first embodiment of surface modification in accordance with this disclosure is through the chemical reaction between the epoxy groups of surface modifying agent and the hydroxyl, carboxylic, or amino groups generated from the hydrolysis of polyester fibers.

Hydrolysis reveals functional groups on polyester for further reactions. Reactions can be conducted in either alkaline or amine solutions. A sample of proper size is pre-wetted prior to hydrolysis. Wetting can be conducted either by using a wetting agent, a surfactant, or simply by dipping the sample in an aqueous alcohol solution. Wetting and hydrolysis can be a two-step process or can be processed in one step. In this embodiment of the disclosure, a sample of Reemay 2295 is soaked in a solution that contains from 20-25% methanol, preferably 23% methanol, 0.1-0.3% sodium hydroxide, preferably 0.2% sodium hydroxide. The reaction temperature can be from room temperature to the boiling point of the solution. However, the temperature must be sufficiently low enough to avoid excessive hydrolysis of the polyester which may weaken the substrate. In this embodiment, a temperature of 25-85° C., and preferably 60-70° C., were been used to perform the hydrolysis.

When hydrolysis is conducted in an amine solution, the reaction can be presented by the following equation:

˜CO—C₆H₄—CO₂—CH₂—CH₂—O˜+RNH₂→˜CO—C₆H₄—CO—NHR+HO—CH₂—CH₂—O˜

This is a nucleophilic substitution reaction, called aminolysis, in which the electron-rich amine will attack electron-deficient carbonyl carbon of carboxylic group and cause chain scission at this site.

When hydrolysis is conducted in an alkaline solution such as in NaOH solution, the reaction can be presented by the following equation:

˜CO—C₆H₄—CO₂—CH₂—CH₂—O˜+NaOH→˜CO—C₆H₄—CO₂⁻+HO—CH₂—CH₂—O˜

This is also a nucleophilic substitution reaction, called alkaline hydrolysis, in which the electron-rich hydroxide attacks electron-deficient carbonyl carbon of carboxylic group and cause chain scission at this site.

Both reactions cause the molecular weight of polyester to reduce. Excessive hydrolysis should be avoided for applications requiring sufficient mechanical strength as it may make the polyester fabric too weak to be useful for such applications.

Polyesters such as PET and PBT, after reacting with alkaline or amine solution in a controlled manner, open up new functional carboxylic or amino and hydroxyl groups. Each of these groups can further react with an epoxy group. Examples of groups of compounds which carry epoxy groups and can be utilized in the present disclosure are described herein below.

The first group comprises available charge-carrying polymers that carry epoxy group on their repeat units, such as Resicart E (Ciba-Geigy), shown below.

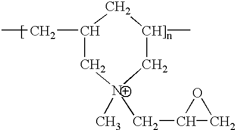

The second group comprises an acrylic-epoxy monomer (such as GMA) polymerized with another acrylic monomer that carries a charge. Example of other monomers is 2-acrylamido-2-methyl-1-propanesulfonic acid (CAS 15214-89-8), and thus, offer charges to substrate polyester after the reaction of epoxy group of GMA with carboxylic or amino and hydroxyl groups on substrate. This is illustrated below:

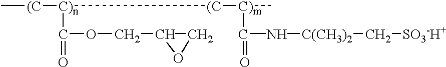

Another example of another monomer is diethyl aminoethyl methacrylate (DEAEMA) with a reacted polymer structure shown below:

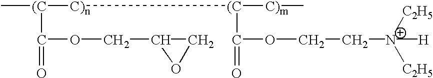

The third group comprises modifying agents that are adducts of a multi-epoxy compound such as Heloxy 67 and a multi-amine molecule such as tetraethylenepentamine (TEPA).

The fourth group comprises modifying agents that are condensed products of epichlorohydrin with a high molecular weight polymer with an amine functionality on the main chain. An example is given below:

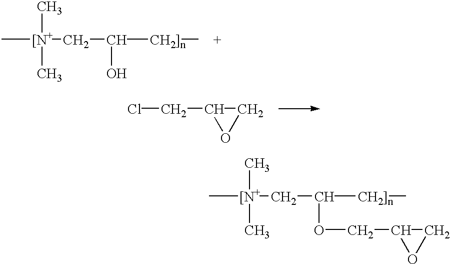

The fifth group comprises an acrylic-epoxy monomer such as GMA which can be polymerized with a vinyl monomer that has a special functional group, such as a styrene sulfonic acid group, which would impart anionic charge modification.

The sixth group comprises monomers containing hydroxyl groups such as hydroxyl ethyl methacrylate (HEMA) or hydroxyl propyl acrylate (HPA) can polymerize with epoxy-containing acrylate such as GMA and after reacting onto polyester, the polymer can alter the surface energy of the polyester, making it more hydrophilic.

The seventh group comprises monomers such as fluoroalkyl methacrylate or acrylate could be polymerized with epoxy-containing acrylate such as GMA to alter the surface energy of the polyester, making it more hydrophobic.

The reaction scheme is believed to proceed as follows:

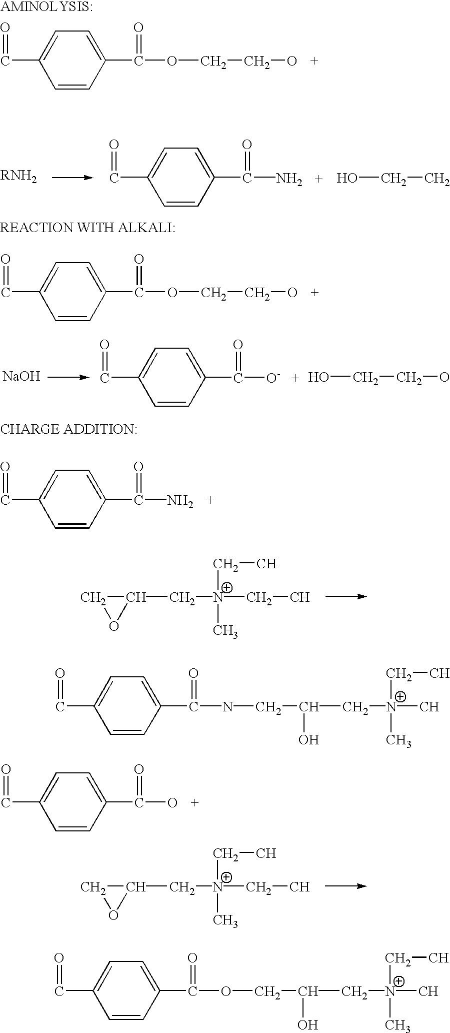

The amine used in the aminolysis reaction is preferably of the aliphatic type or is predominantly aliphatic in nature. Aliphatic amines have been found to provide improved results as compared to aromatic amines. In particular, aliphatic amines coming within the ethyleneamine and propyleneamine group of compounds has been discovered to be particularly efficacious. Aliphatic amines comprising more than one reactive amine group have been seen to be significantly more effective than monoamines in inducing aminolysis.

While sodium hydroxide is shown in the above reaction scheme, as would be understood by one of ordinary skill in the art, other alkaline agents may be advantageously employed. Advantageously, the pH of the solution to which the polyester is exposed is greater than about 7, more preferably greater than about 8, and yet more preferably greater than about 9.

As shown, the presently preferred charge-modifier of the present disclosure is a poly-epoxyamine. While one or more amine functionalit(ies) of such charge modifier is preferably quaternary, when a positive zeta potential is desired, the charge modifier may comprise primary, secondary or tertiary amines. When used in a solution with a pH greater than about 7, the poly-epoxyamine preferably comprises one or more quaternary amines. However, as would be understood by one of ordinary skill in the art, other ions other than ammonium ions which have a fixed formal positive charge group may be used as well.

The dye scavenging capacity of polyester fabric reacted without aminolysis (i.e. reacted with the poly-epoxyamine and sodium hydroxide alone), while significantly better than polyester fabric treated with sodium hydroxide and a haloglycidylammonium monomer, was found to be significantly reduced as compared to the capacity of such fabric when the fabric was also reacted with an amine compound to cause aminolysis of the polyester. While not being bound by any theory, it is believed that the improved charge capacity of the fabric is due to an improved binding between the amine group of the charge modifier and the polyester substrate due both to the improved bonding caused by aminolysis with the amine and due to the polymerized form of epoxyamine utilized.

The present inventors have discovered that aminolysis of polyester substrate made from linear poly(ethylene terphthalate), in conjunction with alkaline hydrolysis of the polyester, significantly improves the anionic dye binding capacity of the treated polyester when further treated with epoxy charge-modifiers having a fixed formal positive charge group, in particular glycidyltrialkylammonium compounds. The present inventors have also discovered that polymerized epoxy-containing charge-modifiers permit significantly more charge to be built up on many substrates as opposed to their monomeric analogs.

In a presently preferred embodiment of the present disclosure, polyester material is treated with an aliphatic polyamine and/or a strong alkaline compound to cause alkaline hydrolysis prior to, or concurrent with, treatment of the material with the poly-epoxy charge-modifier. A particularly presently preferred aliphatic polyamine has been found to be tetraethylene pentamine (H₂N(CH₂CH₂NH)₃CH₂CH₂NH₂). Numerous alkaline agents can be used as long as the agent can induce hydrolysis of the polyester to produce free carboxyl groups; however, amine linking agents are presently preferred. For economic reasons, it is presently preferred that the alkaline agent used to cause alkaline hydrolysis of the polyester be a strong base such as sodium or potassium hydroxide.

It is presently preferred that either prior to, or concurrent with, reaction with the alkaline agent that the material be wetted with an alcohol solution, presently preferably about 10-30% methanol.

The epoxy charge-modifier with fixed formal positive charge is preferentially polymeric in form, comprised of two or more repeating units, more preferably 50 or more repeating units, and more preferably 100 or more repeating units. While the charge modifier may comprise primary, secondary, tertiary or quaternary amines, quaternary amines are presently preferred as they maintain charge in substantially all pH ranges, including alkaline pH. Quaternary amines are particularly presently preferred when the pH of the washing fluid is higher than about 7.

The treated polyester may be dried after all treatments (it is not necessary to dry the treated polyester substrates until all desired treatments are complete). Treated polyester substrate can be prepared by a number of methods, as would be understood by one of ordinary skill in the art from the present disclosure.

In one method polyester substrate undergoes alkaline hydrolysis and the resulting intermediate is then charged modified with an epoxy charge-modifier, such as an aliphatic diepoxide or quaternary polyaminoepichlorohydrin resin. In another method, the polyester substrate is treated to cause aminolysis of the polyester, and then the resulting intermediate is reacted with an epoxy charge-modifier. In yet another method, the polyester substrate is exposed to a bath containing alkaline agents and amines sufficient to cause both alkaline hydrolysis and aminolysis, and the resulting intermediate then treated with an epoxy charge-modifier. And yet in another method, the polyester substrate is exposed to a bath containing alkaline agents, amines, and an epoxy charge-modifier in sufficient concentration to cause aminolysis, alkaline hydrolysis, and charge-modification by chemical reaction of the epoxy charge-modifier with the modified polyester substrate.

In one presently preferred embodiment of the present disclosure, there is disclosed a process for removing anionic materials from a liquid comprising exposing the liquid to a cationically charge-modified polyester substrate having a positive zeta potential such that the metanil yellow binding capacity is at least about 0.004 mg metanil/1.0 gram of substrate , the charge-modified polyester substrate comprising: (a) polyester; (b) a polymeric cationic charge-modifying agent, the cationic charge-modifying agent being chemically bonded to the polyester.

In other embodiments of the present disclosure, the surface modifier which reacts with the polyester may have one or more epoxy groups associated with one or more hydroxyl groups that results in a polyester surface which is substantially hydrophilic, one or more epoxy groups associated with one or more ethylene oxide groups that results in a polyester surface which is substantially hydrophilic, one or more epoxy groups associated with one or more hydroxyl and ethylene oxide groups that results in a polyester surface which is substantially hydrophilic, or one or more epoxy groups associated with one or more groups having one or more fluorine atoms that results in a polyester surface which is substantially hydrophobic.

### A Method for Measuring Metanil Yellow Dye Capacity

Metanil yellow dye, which has a molecular weight of approximately 375.38, is used to measure the positive charge capacity of charge-modified polyester fabric. A static soaking method is performed. Metanil yellow solution at about 10 ppm concentration is prepared in a phosphate buffer at about pH 9. The media is soaked and then removed. The absorbence of the supernatant liquid is measured at a wavelength of about 430 nm and compared to a blank solution containing everything but the dye. The total metanil yellow bound was calculated as follows:

TOTAL METANIL YELLOW BOUND IN MILLIGRAMS=(A_{I}−A_{F})/A_{I}×(MG DYE IN OFFERED VOLUME)

Total metanil yellow bound in milligrams=(Aᵢ−A_{f})/Aᵢ×(mg dye in offered volume)

where Aᵢ=the initial absorbence at 430 nm (blank) and A_{f}=final absorbence at 430 nm (test). The milligrams of dye in the offered volume may be easily calculated by using a standardized liter solution. For example, as 10 ppm=10 mg/1=10 mg/1000 ml, if 10 ml are used in the study, there are 0.1 milligrams in 10 milliliters.

The total metanil yellow in milligrams bound can then be divided by the weight of media to provide milligrams of metanil yellow per grams of media.

Metanil binding may also be expressed as a function of available surface area (rather than weight of substrate). Such measurement is typically a better indication of charge as the extent of charge modifications is a function of surface area rather than weight.

Now turning to the illustrations, there are shown several possible reaction schemes which are encompassed within the scope of the present disclosure.

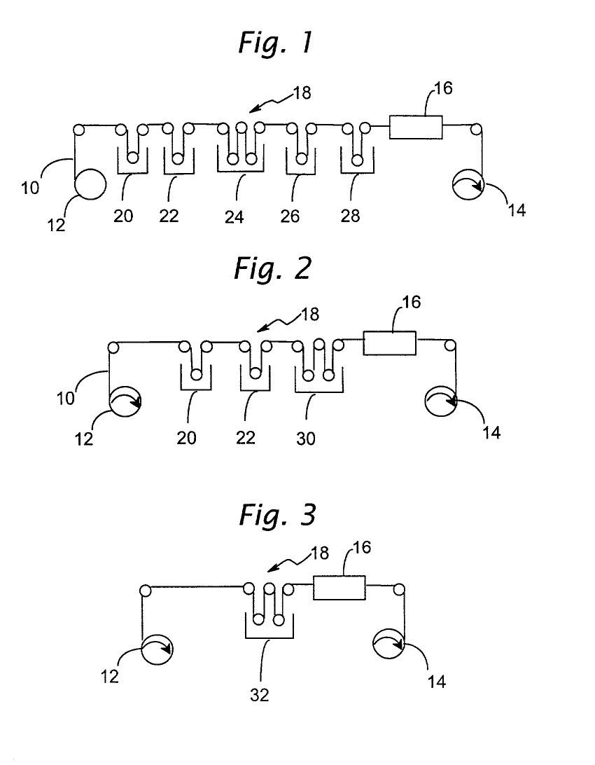

FIG. 1 illustrates a two-stage reaction scheme wherein polyester substrate 10 unwound from source spool 12 is exposed to several chemical-treatments upon passage of polyester substrate 10 through a series of rollers 18 onto uptake spool 14. Polyester substrate 10 is shown to pass through pre-wet solution 20, rinse solution 22, aminolysis solution 24, rinse solution 26, and poly-epoxy charge modifier solution 28 which may include an alkaline agent to induce hydrolysis. The polyester substrate is then dried in oven 16 before being wound onto uptake spool 14.

FIG. 2 illustrates a one stage reaction wherein polyester substrate 10 unwound from source spool 12 is exposed to one chemical-treatment upon passage of polyester substrate 10 through a series of rollers 18 onto uptake spool 14. Again polyester substrate 10 passes through pre-wet solution 20 and rinse solution 22. Polyester substrate 10 then passes through a solution containing a poly-epoxy charge-modifier, an alkaline agent and/or polyamine. The polyester is then dried in oven 16 before being wound onto uptake spool 14.

FIG. 3 illustrates a reaction scheme wherein polyester substrate 10 is not pre-wetted and rinsed prior to exposure to the charge-modifier. In this reaction scheme, polyester substrate 10 unwound from source spool 12 is exposed to one solution 32 upon passage of polyester substrate 10 through a series of rollers 18 onto uptake spool 14. Solution 32 comprises wetting agents such as methanol and the polyepoxy charge-modifier in conjunction with an alkaline agent in sufficient quantity to cause hydrolysis of a quantity of polyester substrate, and/or polyamine in sufficient quantity to cause aminolysis of a quantity of polyester substrate. The treated polyester substrate exiting from solution 32 is then dried in oven 16 before being re-wound onto spool 14.

The following examples illustrate the results of experiments using the method in accordance with the present disclosure:

### EXAMPLE 1

### Charge Capacities

Each charged sheet, along with an untreated sheet made from Reemay 2295, was cut into 4-2.25″ squares for metanil yellow (M-Y) dye capacity testing. Duplicate samples were used in the following manner to perform a static M-Y dye test. Two sets of 2 squares were weighed and placed in disposable Petri dishes. A 10-ml solution of 10 ppm of M-Y in pH 9 buffer was pipetted into the dishes and swirled. After one minute, the samples were removed, and the absorbence of the supernatant liquid and the unused dye solution read on the LKB Ultrospec II spectrometer at 430 nm in the standard 1-cm cuvette. Calculations were then performed to determine the sample's capacity for dye.

The mg dye in offered volume is calculated as follows:

For 10 ppm=10 mg/1=10 mg/1000 ml.

As only 10 mls is being used, 10 ml/1000 ml=0.01 *10 mg=0.1 mg in 10 mls

For a typical test, where the blank absorbence of a 10-ppm solution is 0.533 and the absorbence of the test sample's supernatant is 0.142.

The total M-Y bound, mg=(0.533−0.142)/0.533*0.1=0.073

The mg bound can then be divided by the weight of the media or the area used (10.125 cm²) to provide mg M-Y/g media or mg M-Y/cm² media. When challenged with 10 ml of 10-ppm metanil yellow for 1 min., the charge capacities are 0.008 mg/in² or 0.117 mg/g.

### EXAMPLE 2

### Preparation of Charge-modified Polyester Via Amine Hydrolysis

A piece of 2″×2¼″ Hollytex 3257 (a PET spunbond) was wet with 10% methanol and then treated with a 1% tetraethylene pentamine at 70° C. for 30 seconds. The material was then flushed with tap water to remove the excess amount of tetraethylene pentamine. The wet fabric was subsequently dipped into a 2% Rescart-E (poly(N-methyl diallyl amine) epichlorohydrin adduct—Ciba-Geigy) solution for about 5 seconds. The fabric was then dried at 90° C. for thirty minutes.

The treated fabric was then washed in a typical laundry wash containing Tide® detergent and Clorox® at 85° C. for thirty minutes. The fabric was then challenged with Metanil yellow dye and the dye uptake determined. The dye capacity of the fabric was determined to be 0.005 mg/g of polyester substrate.

### EXAMPLE 3

### Preparation of Charge-modified Polyester Via NaOH Hydrolysis I

A piece of 6″×6″ Reemay 2295, a spunbond with 2.2 denier fiber and 100 gms basis weight was placed in a reactor that contained 0.2 grams sodium hydroxide, 0.2 grams of methanol, and 2 ml of a 20% solution of Resicart-E (poly(N-methyl diallyl amine) epichlorohydrin adduct—Ciba-Geigy). Water was added to reactor to result in a total volume of 100 milliliters. The reactor temperature was maintained at 65° C.

The treated fabric was then dried and challenged with metanil yellow dye. The dye capacity of the fabric was determined to be about 0.005 mg/g of polyester substrate.

### EXAMPLE 4

### Preparation of Charge-modified Polyester Via NaOH Hydrolysis II

A charge-modifying agent is a copolymer of GMA and DEAEMA. GMA and DEAEMA were charged into a reactor in a weight ratio of 1:10 in a D.I. water medium with the pH of the solution adjusted to 3.5 to 4.5. The reaction was carried out in a nitrogen atmosphere at 80° C. in the presence of free-radical initiator APS and promoter STS. After the completion of the reaction, the solution became an opalescent white and viscosity increased slightly. Eighty ml of this solution was adjusted to pH>12 with NaOH, and 20 ml of MeOH were added to provide hydrophilicity. Two 7-inch squares of Reemay 2295 was added to the solution at room temperature for two minutes, put through the wringer and then dried at 105° C. The nitrogen content via Kjeldahl nitrogen analysis of control Reemay 2295 as <0.21 mg N₂/g, and the DEAEMA-GMA treated sample as 2.5 mg N2/g.

### EXAMPLE 5

### Preparation of Hydrophilic Polyester Fabric

The hydrophilic modifying agent is a copolymer of GMA and PEGMA. GMA and PEGMA were charged into a reactor in a weight ratio of 1:20 in a DI water medium with the pH of the solution adjusted to 4.0. The reaction was carried out in a nitrogen atmosphere at 80° C. in the presence of free-radical initiator APS and promoter STS. After approximately 30 minutes, a slight translucence was seen, which over 4 hours also showed a slight increase in viscosity.

### EXAMPLE 6

### Acid Dye Removal by Charge-modified Polyester Fabric

Three different wash water from washing new colored articles were collected—red, blue and green. A positively charged polyester made from Example 3 was cut into 2″×2″ square and threw in a bottle of 50 ml colored water. Dyes of three different color can be removed within 5 minutes and leave the solution colorless.

### EXAMPLE 7

### Change of Surface Tension of Surface-modified Polyester Fabric

Twenty-five ml of the solution prepared in Example 5 was brought to pH 13 by the addition of 5N NaOH. The solution was brought to 65° C., and 4 ml of methanol was added and a 7×8 inch rectangle of Hollytex 3257 was saturated for 2 minutes. The material was dried in a 72° C. oven, washed with water and re-dried. Single drops of DI water and saturated NaCl solution were timed to disappearance in a test for hydrophilicity. Wetting results were indicated in the following table.

| | DI, Avg. wetting | |
|---|---|---|
| Samples | time | Sat. NaCl, Avg. time |
| Untreated Hollytex 3257 | 22.72 sec | 156.14 sec |
| Water-rinsed 0726A | 13.19 | 22.72 |

The above examples illustrate some of the methods in accordance with the present disclosure used to modify the surface of the polyester substrate to impart various characteristics to the polyester surface.

Treatment of the dye scavenging material may take place using a multi- or single-step process. For example, the material may be processed sequentially through a pre-wet solution, a rinse, an alkaline solution, a rinse, an aliphatic polyamine solution, a rinse, and then a poly-epoxyamine solution (and then dried). The material may also be processed sequentially through a pre-wet solution, a rinse, and a solution containing both the poly-epoxyamine and the alkaline agent prior to drying. The material may also be processed by running it through a solution containing the poly-epoxyamine and alkaline agent along with an agent to promote drying (such as methanol).

While the disclosure has been described with respect to presently preferred embodiments, those skilled in the art will readily appreciate that various changes and/or modifications can be made to the disclosure without departing from the spirit or scope of the disclosure as defined by the appended claims. All documents cited herein are incorporated in their entirety herein.

What is claimed is:

1. A process for preparing a charge-modified polyester substrate, said process comprising the steps of:
(a) treating the substrate with an alkaline agent so as to cause alkaline hydrolysis of polyester in said substrate;
(b) applying to the treated substrate of step (a) a poly-epoxy charge-modifier having a fixed formal positive charge, one or more epoxy groups of said charge-modifier being capable of bonding to said treated substrate; and
(c) drying the treated material.

2. The process as recited in claim 1 wherein step (a) takes place concurrent with step (b).

3. The process as recited in claim 1 wherein step (a) takes place before step (b).

4. A process for preparing a charge modified polyester substrate, said process comprising the steps of:
(a) treating the substrate with an amine agent so as to cause aminolysis of polyester in said substrate;
(b) applying to the treated substrate of step (a) a poly-epoxy charge-modifier having a fixed formal positive charge, one or more epoxy groups of said charge-modifier being capable of bonding to said treated substrate; and
(c) drying the treated material.

5. The process as recited in claim 4 wherein step (a) takes place concurrent with step (b).

6. The process as recited in claim 4 wherein step (a) takes place before step (b).

7. A process for preparing a charge-modified polyester substrate, said process comprising the steps of:
(a) treating the substrate with an alkaline agent so as to cause alkaline hydrolysis of polyester in said substrate and with an amine compound so as to cause aminolysis of polyester in said substrate;
(b) applying to the treated substrate of step (a) a poly-epoxy charge modifier having a fixed formal positive charge, one or more epoxy groups of said charge modifier being capable of bonding to said treated substrate; and
(c) drying the treated material.

8. The process as recited in claim 7 wherein step (a) takes place concurrent with step (b).

9. The process as recited in claim 7 wherein step (a) takes place before step (b).

10. A process for removing anionic materials from a liquid comprising exposing the liquid to a cationically charge-modified polyester substrate having a positive zeta potential of such magnitude that the metanil yellow binding capacity is at least 0.004 mg of metanil per 1.0 grams of substrate, said charge-modified polyester substrate comprising:
(a) polyester substrate; and
(b) a polymeric cationic charge-modifying agent, said cationic charge modifying agent being chemically bonded to said polyester substrate.

11. A process for cationically charge-modifying a substrate comprising polyester, said process comprising:
(a) chemically bonding a charge-modifying amount of a cationic charge-modifying agent to the substrate so as to charge-modify substantially all of said polyester, wherein the charge-modifying agent comprises a polymer consisting of a plurality of monomers each bearing a fixed formal positive charge and one or more epoxide groups, said epoxy groups capable of reacting with said polyester to form a chemical bond when said polyester is exposed to a quantity of alkaline agent(s) sufficient to cause alkaline hydrolysis of the polyester and/or a quantity of amine compounds sufficient to cause aminolysis of the polyester; and
(b) drying the treated material.

12. A process for preparing a charge-modified polyester substrate, comprising:
(a) applying to the substrate a charge-modifying system comprising:
a charge modifying agent comprising one or more epoxy groups and fixed formal positive charged groups, said epoxy groups capable of bonding to the surface of said polyester substrate when the polyester is said substrate is chemically modified to produce free carboxy or amine functionalities;
an alkaline agent in sufficient concentration to cause hydrolysis of the polyester in said substrate;
an aliphatic polyamine in sufficient concentration to cause aminolysis of the polyester in said substrate; and
(b) drying the treated material.

13. The method as recited in claim 12 wherein the aliphatic polyamine is tetraethylene pentamine.

14. A method for producing a positively-charged polyester substrate, said method comprising:
(a) immersing a polyester substrate into an aqueous organic solvent containing a polyamine in a concentration, and for a time, sufficient to cause aminolysis of said polyester in said polyester substrate;
(b) reacting the polyester substrate of step (a) with a poly-epoxy charge-modifying agent carrying a fixed formal positive charge;
(c) drying the polyester substrate of step (b).

15. A method for producing a positively-charged polyester substrate, said method comprising:
(a) immersing a substrate comprising polyester into a solvent containing an alkaline agent in a concentration, and for a period of time sufficient to cause hydrolysis of said polyester;
(b) reacting the substrate of step (a) with a poly-epoxy charge-modifying agent carrying a fixed formal positive charge
(c) drying the substrate of step (b).

16. A method for modifying polyester, comprising:
exposing a substrate of polyester to at least one agent sufficient to cause hydrolysis of the polyester and at least one modifier comprising one or more epoxy groups, wherein the one or more epoxy groups of the at least one modifier form a bond with the polyester.

17. The method of claim 16 wherein the one or more epoxy groups are associated with a fixed negative charge.

18. The method of claim 16 wherein the one or more epoxy groups are associated with a fixed positive charge.

19. The method of claim 16, wherein the at least one agent is an alkaline.

20. The method of claim 16, wherein the at least one agent is an amine.

21. The method of claim 16, further comprising: drying the resulting polyester.

22. The method of claim 16, wherein the at least one agent comprises: at least one alkaline and at least one amine.

23. The method of claim 16, wherein the polyester is exposed to the at least one agent before being exposed to the modifier.

24. The method of claim 16, wherein the polyester is exposed to the at least one agent and the modifier concurrently.

25. The method of claim 16 wherein the one or more epoxy groups are associated with one or more hydroxyl groups.

26. The method of claim 16 wherein the one or more epoxy groups are associated with one or more ethylene oxide groups.

27. The method of claim 16 wherein the one or more epoxy groups are associated with one or more hydroxyl and ethylene oxide groups.

28. The method of claim 16 wherein the one or more epoxy groups are associated with one or more groups having one or more fluorine atoms.
